(19) United States
(12) Patent Application Publication
(10) Pub. No.: US 2024/0036864 A1
(43) Pub. Date: Feb. 1, 2024

(54) APPARATUS EMPLOYING WRAP TRACKING FOR ADDRESSING DATA OVERFLOW

(71) Applicant: QUALCOMM Incorporated, San Diego, CA (US)

(72) Inventors: Aniket Bhivasen Bhor, San Jose, CA (US); Huzefa Sanjeliwala, Austin, TX (US); Ajay Kumar Rathee, San Jose, CA (US)

(21) Appl. No.: 17/816,513

(22) Filed: Aug. 1, 2022

(51) Int. Cl. G06F 9/38; G06F 9/30

(52) U.S. Cl. CPC G06F 9/3814; G06F 9/30058; G06F 9/30065; G06F 9/3861

(57) ABSTRACT

An apparatus includes a circular buffer which includes a fixed number of entries and allows data overflow to occur while maintaining the most recently stored entries in order. The circular buffer could be used as a return address stack used to push and pop return addresses for subroutine calls in a processor. Additional circuitry dynamically links entries to maintain a last-in first-out stack. A system return pointer tracks the next entry to be returned when an entry is to be read. When data is pushed to an entry in the circular buffer, that entry stores a pointer to the entry for the previous system return pointer. By tracking the previous system return pointer in the pushed entry, the dynamically linked entries may skip intervening entries that have been previously popped and, thus, track the order of most recently written non-popped entries without having to separately maintain free and used lists.

### BACKGROUND

### I. Field of the Disclosure

The technology of the disclosure relates generally to data buffer overflow, and, more particularly, an efficient apparatus for addressing data buffer overflow in computer microarchitectures.

### II. BACKGROUND

Computer software programming constructs include subroutines for grouping a set of instructions together that are frequently called to perform a task or operation. When programs that include calls to subroutines are compiled, the compiled program will include a call instruction to a subroutine that jumps to the program address of the subroutine. The compiler will also include an instruction in the subroutine that is a return instruction to exit the subroutine when its execution is completed. When a processor executes a subroutine, the processor must determine the program return address to return to when the return instruction is processed. In the context of computer microarchitecture, conventional processors utilize a return address stack (RAS) to track return addresses resulting from subroutine calls so that the processor can determine which program address to return to after execution of the subroutine execution is completed. When a processor encounters a call instruction to a subroutine, the processor adds or pushes the return address to the RAS. Thus, when the processor encounters a return instruction, the processor reads or pops the return address off the RAS to then return to executing instructions starting at the return address.

RAS systems are fixed data buffers that are utilized to preserve return addresses from call type instructions. Since return address stack systems contain a fixed RAS structure in memory, programs that are executed by a processor may result in overflowing the RAS or, in other words, writing more information in the return address stack than what the stack can physically store. Conventional return address stack systems may or may not address overflow situations. However, due to today's deep processor pipelines and their use of predictive instruction fetching, a computer architecture design must also address managing return addresses when a branch instruction is deemed by the processor to have been mispredicted.

Some conventional approaches to RAS systems preclude overflow situations to occur altogether. Those approaches limit the number of new entries to be added to the RAS which, on overflow conditions, result in mismatches between added entries due to a specific call and the return address that are returned from the RAS. Consequently, those conventional RAS systems have defined their fixed RAS to be larger and larger to delay but not prevent data overflow. Additionally, on branch instruction mispredicts, all the entries in these conventional RAS systems are reset, or in other words, flushed, thereby losing any history of the return addresses. Other conventional RAS systems that address data overflow situations utilize a tracking system for valid/invalid entries in the RAS. Those conventional tracking systems include a checkpoint table to save the state of RAS on each call type instruction. In particular, before writing an entry to the RAS on a call type instruction, the tracking system in those conventional RAS systems perform a content addressable memory (CAM) search on the checkpoint table each time a call type instruction is received to make sure the RAS entry that will be returned next has been previously retired or committed. If the entry has been previously retired or committed, this entry is available. Otherwise, those conventional approaches have to find an available entry in a separately managed free list of entries and manage the order of the list of valid entries. CAM searches consume energy and impact system performance.

In order to save processing power and improve performance, there is a need for a more efficient data apparatus which can address data overflow while reducing overhead such as those incurred by CAM searches.

### SUMMARY

Aspects disclosed in the detailed description include an apparatus employing wrap tracking for addressing data overflow. In an example, the apparatus includes a circular buffer which includes a fixed number of entries for data storage and allows data overflow to occur while maintaining the most recently stored data entries in order. For example, the circular buffer could be used as a return address stack (RAS) buffer used to push and pop return addresses for subroutine calls in a processor. In exemplary aspects, the entries in the circular buffer are fixedly linked in a forward direction while dynamically linked in a backward direction. Entries are written or pushed in the forward direction while entries are read or popped in the backward direction. Additional circuitry is utilized to manage the dynamic linking in the backward direction. A system return pointer tracks the next entry to be returned when an entry is to be read. When data is pushed to an entry in the circular buffer, that entry stores a pointer to the entry for the previous system return pointer. By tracking the previous system return pointer in the pushed entry, the backwardly linked buffer may skip intervening entries that have been previously popped and, thus, dynamically track the order of most recently written non-popped entries without having to separately maintain free and used lists within the circular buffer.

In another exemplary aspect, the apparatus is further employed as a return address stack (RAS) with a processor pipeline that employs predictive fetching of instructions. In this example, entries written to and read from circular buffer of the RAS are done speculatively. When employing a return address stack system in accordance with this disclosure along with predictive fetching, the RAS system will also efficiently manage retiring or committing of call type and return instructions. For example, this exemplary aspect will address retiring of a return instruction whose associated data entry in the RAS has already been returned. If the return instruction was part of a correctly predicted branch, the entry associated with the committed return instruction will have already been returned and may have been overwritten by subsequent call instructions thereby removing the need to further process the entry a commit signal. In another aspect, to track the particular circular iteration (i.e., loop count) of the circular buffer in which an entry is written to the buffer, each entry includes a global wrap count value. The global wrap count value is configured to be written with the iteration count of the circular buffer when its entry is written. By utilizing a copied global wrap count in the entries of the circular buffer, the RAS system can track whether an entry associated with retire/commit of a return instruction has been overwritten and thus available, thus, eliminating the need to reset the entry associated with retired instructions. By dynamically linking the return addresses along with the global wrap counter mechanism, the RAS system in the present disclosure tracks whether an entry has been overwritten without the need for CAM searching a checkpoint buffer to find the appropriate entry that needs to be retired and without managing valid/invalid bits to determine if the appropriate entry has been overwritten.

Other aspects of the disclosure will include how this novel approach addresses restoring the state of the RAS on a mispredict of a call type instruction prior to the speculative writing of the RAS entry associated with the call type instruction.

Data buffer overflow, in general, can occur in many use cases. In general, data buffer overflow can occur wherever there is a fixed size buffer and requests to add more entries to the data buffer exceed the fixed buffer size and requests to consume the entries. Aspects of the examples disclosed herein are applicable to addressing data buffer overflow generally.

In this regard, in one exemplary aspect, an apparatus comprising a circular buffer is provided. The apparatus also includes a return pointer register, a global wrap group register and a buffer manager circuit. The circular buffer comprises a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer. The return pointer register is configured to track the most recently added data entry in the fixed number of entries. The global wrap group register is configured to store a value representing the number of iterations the circular buffer has been written. The buffer manager circuit, in response to a write request, is configured to determine a next available entry of the fixed number of entries, update the local wrap group field of the next available entry to the value of the global wrap group register, and update the second field of the next available entry to the value of return pointer register.

In another exemplary aspect, a method for managing a LIFO system is provided. The method includes establishing a circular buffer. The circular buffer comprises a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer. The method further comprises establishing a return pointer register configured to track the most recently added data entry in the fixed number of entries and establishing a global wrap group register configured to store a value representing the number of iterations the circular buffer has been written. In response to a write request, the method comprises determining a next available entry of the fixed number of entries, updating the local wrap group field of the next available entry to the value of the global wrap group register and updating the second field of the next available entry to the value of return pointer register.

In another aspect, a non-transitory computer-readable medium having stored thereon computer executable instructions is provided. When these computer executable instructions are executed by a processor, they cause the processor to establish a circular buffer comprising a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer. These computer executable instructions cause the processor to also establish a return pointer register configured to track the most recently added data entry in the fixed number of entries and establish a global wrap group register configured to store a value representing the number of iterations the circular buffer has been written. In response to a write request, these computer executable instructions cause the processor to determine a next available entry of the fixed number of entries, to update the local wrap group field of the next available entry to the value of the global wrap group register, and to update the second field of the next available entry to the value of return pointer register.

### BRIEF DESCRIPTION OF THE DRAWINGS

FIG. 1 is a block diagram of initialization state of an exemplary Last-In, First-Out (LIFO) system that includes a circular buffer employing wrap tracking for addressing data overflow;

FIG. 2 is a block diagram of the state of LIFO system of FIG. 1 after two (2) write requests;

FIG. 3 is a block diagram of the state of LIFO system of FIG. 2 after a read request;

FIG. 4 is a block diagram of the state of LIFO system of FIG. 3 after each entry in the circular buffer has been written;

FIG. 5 is a block diagram of the state of LIFO system of FIG. 4 after the first entry in the circular buffer has been overwritten without being returned;

FIG. 6 is a block diagram of an exemplary processor-based system that includes a central processing unit (CPU) that includes an instruction processing circuit and a RAS system configured to employ wrap tracking for addressing data overflow and mispredicting of instructions;

FIG. 7 is a block diagram of the state of the RAS system of FIG. 6 after the first entry in the RAS buffer has been overwritten;

FIG. 8 is a block diagram of the state of the RAS system of FIG. 6 when a commit signal is received for a return instruction;

FIG. 9 is a block diagram illustrating of the state of the RAS system in FIG. 6 when a conditional branch instruction has been determined to be mispredicted;

FIG. 10 is a flow chart for operation of a buffer manager circuit which maintains the order of the most recent entries of a circular buffer, including but not limited to the circular buffer in FIGS. 1-5 and the RAS system in FIGS. 6-10; and

FIG. 11 is a block diagram of an exemplary processor-based system that can include a LIFO system, such as the LIFO systems shown in FIGS. 1 and 6, wherein the LIFO system includes a buffer manager circuit configured to at least utilize wrap tracking for addressing data overflow while maintaining the most recently written entries.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a circular buffer employing wrap tracking for addressing data overflow. In an example, the circular buffer is a fixed size circular buffer that includes a fixed number of entries for data storage which allows data overflow to occur while maintaining the most recently stored data entries in order. For example, the circular buffer could be used as a return address stack (RAS) buffer used to push and pop return addresses for subroutine calls in a processor. In exemplary aspects, the entries in the circular buffer are fixedly linked in a forward direction while dynamically linked in a backward direction. Entries are written or pushed in the forward direction while entries are read or popped in the backward direction. Additional circuitry is utilized to manage the dynamic linking in the backward direction. A system return pointer tracks the next entry to be returned when an entry is to be read. In other words, the system return pointer tracks the most recently added entry to the circular buffer. When data is pushed to an entry in the circular buffer, that entry stores a pointer to the entry for the previous system return pointer. By tracking the previous system return pointer in the pushed entry, the backwardly linked buffer may skip intervening entries that have been previously popped and, thus, dynamically track the order of most recently written non-popped entries without having to separately maintain free and used lists within the circular buffer. In another exemplary aspect, the circular buffer is further employed in a processor pipeline that employs predictive fetching of instructions. In this example, entries written to and read from the RAS are done speculatively. When employing a return address stack system in accordance with this disclosure along with predictive fetching, the RAS system will also efficiently manage retiring or committing of call type and return instructions. For example, this exemplary aspect will address retiring of a return instruction whose associated data entry in the RAS has already been returned. If the return instruction was part of a correctly predicted branch, the entry associated with the committed return instruction will have already been returned and may have been overwritten by subsequent call instructions thereby removing the need to further process the entry a commit signal. In another aspect, to track the particular circular iteration (i.e., loop count) of the circular buffer in which an entry is written to the buffer, each entry includes a global wrap count value. The global wrap count value is configured to be written with the iteration count of the circular buffer when its entry is written. By utilizing a copied global wrap count in the entries of the circular buffer, the RAS system can track whether an entry associated with retire/commit of a return instruction has been overwritten and thus available, thus, eliminating the need to reset the entry associated with retired instructions. By dynamically linking of the return addresses along with the global wrap counter mechanism, the RAS system in the present disclosure tracks whether an entry has been overwritten without the need for CAM searching a checkpoint buffer to find the appropriate entry that needs to be retired and without managing valid/invalid bits to determine if the appropriate entry has been overwritten.

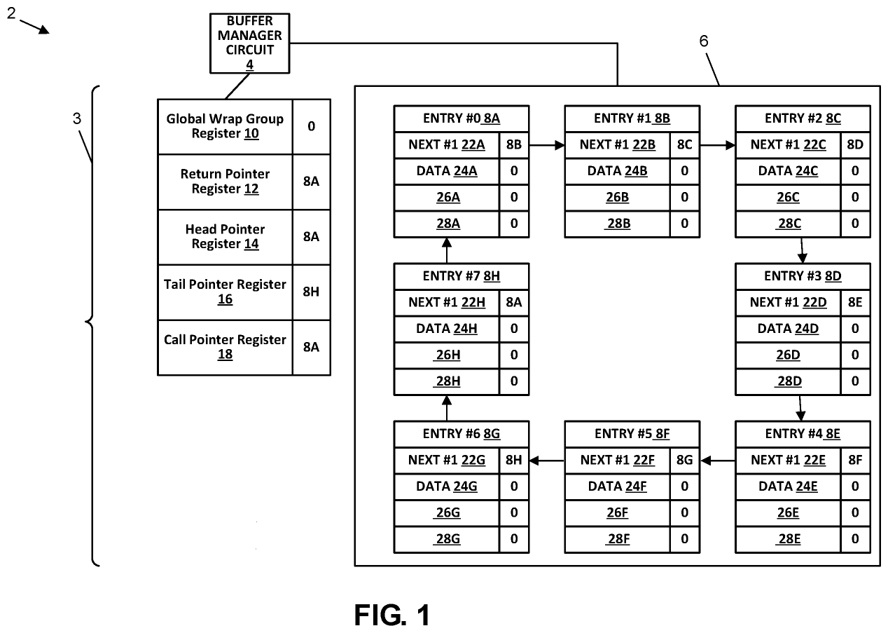

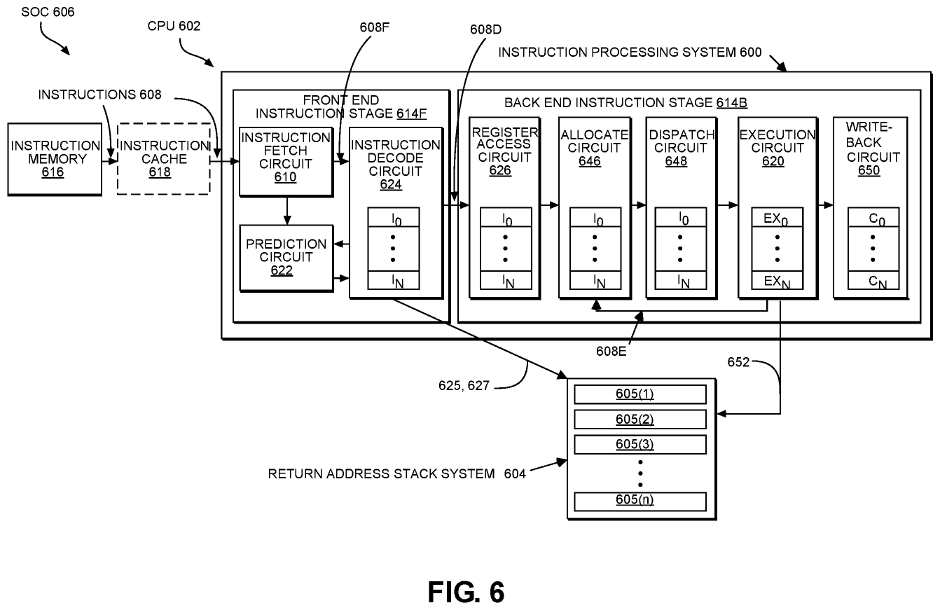

FIGS. 1-5 illustrates various states of an exemplary last-in, first-out (LIFO) system based on a specific set of write and read requests in accordance with the present disclosure. Through this progression, one can understand the exemplary operation of the LIFO system 2 in how it advantageously allows overwriting entries while maintaining a list of most recently written entries. FIGS. 6-10 describe an example of a LIFO system deployed with an instruction processing system. Before discussing an example of the instruction processing system in FIG. 6-10, FIGS. 1-5 are first described below.

In this regard, FIG. 1 is a block diagram of an initialization state 3 of an exemplary LIFO system 2 at initialization in accordance with an example of the present disclosure. As shown in FIG. 1, LIFO system 2 includes a buffer manager circuit 4 and a circular buffer circuit 6, also referred to herein as a “circular buffer 6.” The circular buffer 6 is used to store entries and return individual entries as needed. The circular buffer 6 can be used as a return address stack as will be discussed in connection with FIGS. 6-9. The circular buffer 6 includes eight entries 8A-8H. The buffer manager circuit 4 utilizes a global wrap group register 10 which stores a value representing the number of iterations entries 8A-8H of the circular buffer 6 have been written thus far. The buffer manager circuit 4 also utilizes a return pointer register 12 which stores the address of one of the entries 8A-8H to indicate the particular entry to return on a read request. As will be illustrated later in the discussion, the return pointer register 12 will contain the most recently added entry to the circular buffer 6. At initialization, the global wrap group register 10 and return pointer register 12 are set to zero (0). Please note that for exemplary purposes, the size of the circular buffer 6 is set to eight (8) entries but the concepts described herein may easily be extended to various sizes. Please also note that circuits and registers as described herein are implemented in hardware but that they can also be implemented in software logic and software variables.

In this example, the buffer manager circuit 4 also utilizes head pointer register 14 which stores the address of one of the entries 8A-8H to indicate the start of a list within circular buffer 6 and tail pointer register 16 which stores the address of one of the entries 8A-8H to indicate the end of a list within circular buffer 6. At initialization, the head pointer register 14 is set to the address of entry 8A and the tail pointer register 16 is set to the address of entry 8H. The buffer manager circuit 4 may also utilize a call pointer register 18 which stores the address of one of the entries 8A-8H to indicate the entry of circular buffer 6 to write to on the next write request. A write request may be a result of a subroutine call instruction. At initialization, the call pointer register 18 and the return pointer register 12 are set to the address of entry 8A.

Entries 8A-8H include a next field 22A-22H, a data field 24A-24H, a backward link fields 26A-26H, and a local wrap group field 28A-28H. Next field 22A contains the address of the next forward entry in circular buffer 6. As illustrated in FIG. 1, entry 8A's next field 22A contains the address of entry 8B, entry 8B's next field 22B contains the address of entry 8C, and so on through to the entry 8H linking the entries clockwise in a circular fashion. Thus, next fields 22A-22H statically link entries 8A-8H in a forward direction.

Data fields 24A-24H contain the data to be returned when the respective entry is read. Data fields 24A-24H are initialized to zero but, in this example, will eventually contain data that will be read as a result of a read request. Data fields 24A-24H can include any type of data including values and addresses. Backward link fields 26A-26H are initially set to zero. In response to a write request, the backward link field of the written entry will contain the address of the next entry to return after the written entry is returned. As will be described later, backward link fields 26A-26H will form a list of entries to be read on a series of read requests. Local wrap group fields 28A-28H are initialized to zero and contain the iteration number of when the respective entry was written. As discussed later, the local wrap group field 28A-28H will be assigned to the current value of the global wrap group register 10 at the time a respective entry 8A-8H is written as a result of write request.

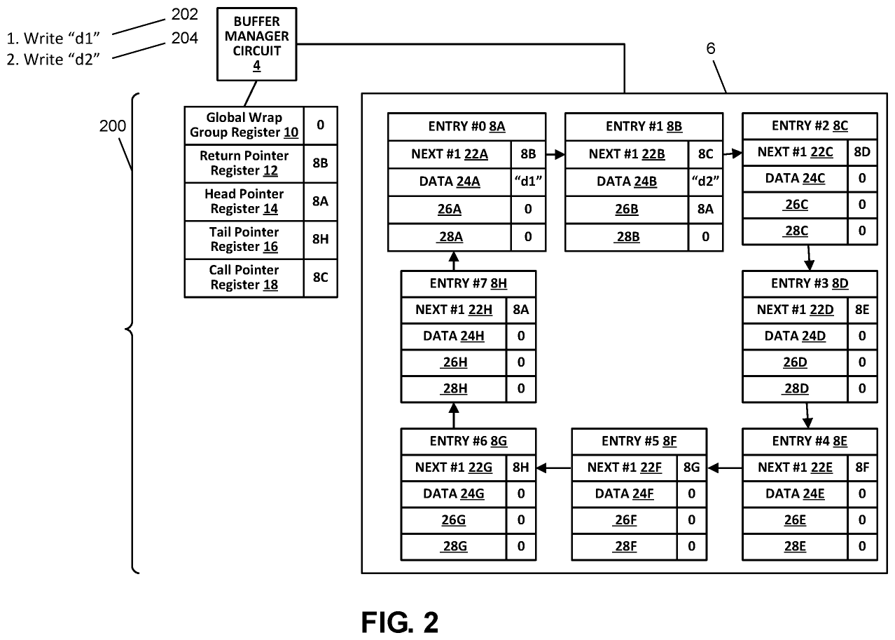

FIG. 2 is a block diagram of the state 200 of LIFO system 2 of FIG. 1 after two write requests, first write request 202 and second write request 204. In response to the first write request 202, buffer manager circuit 4 writes to entry 8A, also known as “entry #0,” since that was where call pointer register 18 was pointing at initialization. In particular, buffer manager circuit 4 writes “d1” to data field 24A, 0 to backward link field 26A since it was the first entry written after initialization, and 0 to local wrap group field 28A since that was the value of the global wrap group register 10 at the time buffer manager circuit 4 writes to entry 8A in response to the first write request 202. Although not shown in FIG. 2, after writing entry 8A in response to the first write request 202, buffer manager circuit 4 would advance call pointer register 18 by copying the address from the next field 22A to contain the address of entry 8B, which is the next entry to write to. Also, not shown in FIG. 2, after writing the first write request 202, buffer manager circuit 4 would set return pointer register 12 to contain the address of entry 8A, since entry 8A would be returned if a read request is received by the buffer manager circuit 4 prior to a subsequent write request.

In response to the second write request 204, buffer manager circuit 4 writes to entry 8B and, in particular, writes “d2” to data field 24B, address of entry 8A to backward link field 26B since it was the value of the return pointer register 12 after processing the first write request 202, and 0 to local wrap group field 28B since that was the value of the global wrap group register 10 at the time buffer manager circuit 4 writes to entry 8B in response to the second write request 204. After writing entry 8B in response to the second write request 204, buffer manager circuit 4 would advance call pointer register 18 by copying the address from the next field 22B to contain the address of entry 8C, which is the next entry to write to. Also, after writing entry 8B in response to the second write request 204, buffer manager circuit 4 sets return pointer register 12 to contain the address of entry 8B, since entry 8B would be returned if a read request is received by the buffer manager circuit 4 prior to a subsequent write request. As can be seen in FIG. 2, the entries between the call pointer register 18 and the tail pointer register 16 are available to be written to.

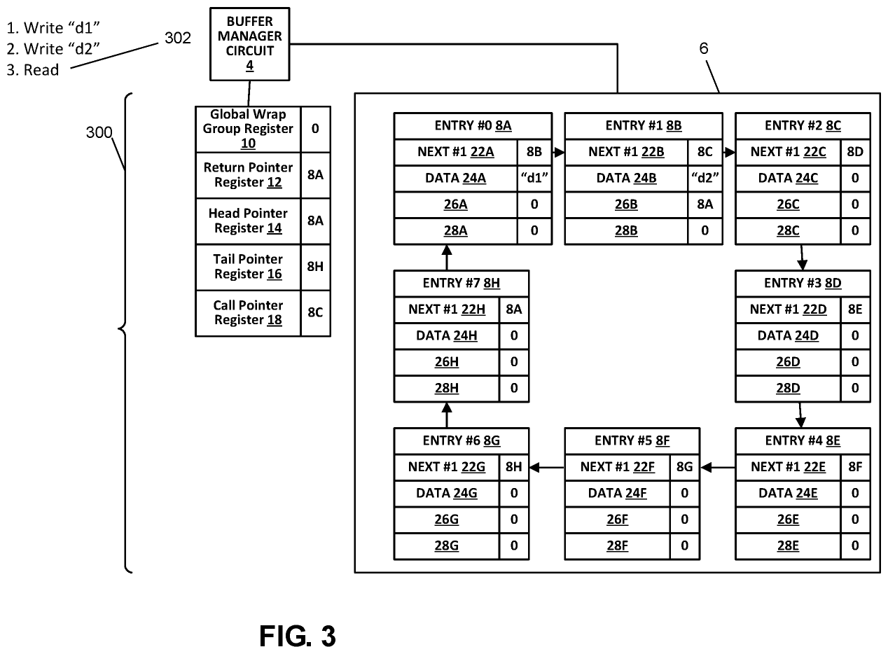

FIG. 3 is a block diagram of the state 300 of LIFO system 2 of FIG. 2 after a read request 302. In response to read request 302, buffer manager circuit 4 reads the address pointed to by return pointer register 12 which was entry 8B (see FIG. 2) and returns the value of “d2” from entry 8B. Also, buffer manager circuit 4, in response to a read request, sets the return pointer register 12 to the address of entry 8A by copying the backward link field 26B to the return pointer register 12. From the description of FIGS. 1-3, one can recognize the LIFO operation in that the last written entry is returned from a buffer of two written entries 8A and 8B.

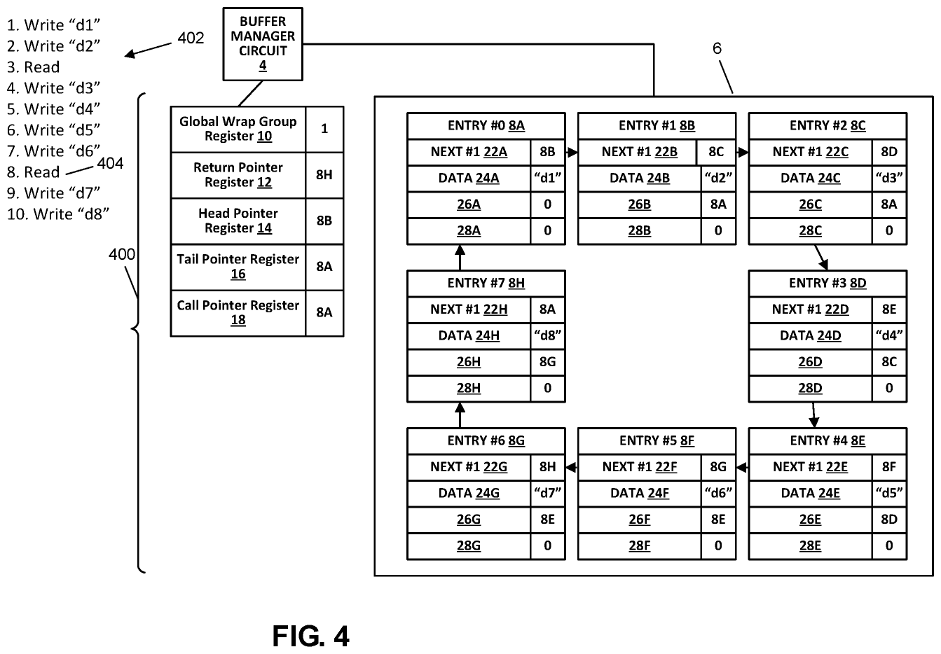

FIG. 4 is a block diagram of the state 400 of LIFO system 2 of FIG. 3 after each entry in the circular buffer has been written by the buffer manager circuit 4 according to the list of write and read requests 402. Following the same operation as discussed for the buffer manager circuit 4 for write and read requests in FIGS. 2-3, FIG. 4 illustrates the state of each of the entries 8A-8H and the buffer manager circuit 4 after processing the last write request in the list of write and read requests 402. Please note the following: all the data fields of entries 8A-8H have been written to with the data associated with the write requests in the list of write and read requests 402. There were two read requests, read request 302 corresponding to returning entry 8B (see FIG. 3) and read request 404 corresponding to returning entry 8F. Due to those read requests and subsequent write requests, please note that entries 8B and 8F are not referenced in any of the backward link fields of entries 8A-8H. As one can see in FIG. 4, the path of backward linked entries, beginning with the entry pointed to by the return pointer register 12 or entry 8H, tracks a list of the most recently written entries to circular buffer 6 that have not been returned.

In processing the last write request and before the entry has been written, the buffer manager circuit 4 checks whether the current call pointer register 18 is equal to the current tail pointer register 16. In this case they were, so the buffer manager circuit 4 advances the head pointer register 14 and tail pointer register 16 one entry to point to entries 8B and 8A, respectively. The buffer manager circuit 4 also increments the global wrap group register 10 since the next entry to be written is entry 8A and will be the second time it has been written to. Logically, the buffer manager circuit 4 increments the current global wrap group register when it is equal to the local wrap group field of the entry pointed to by the updated tail pointer register 16. In other words, the global wrap group register is incremented each time the first entry 8A is overwritten. The buffer manager circuit 4 will also advance the call pointer register 18 and return pointer register 12 as described in FIG. 2 for handling a write request.

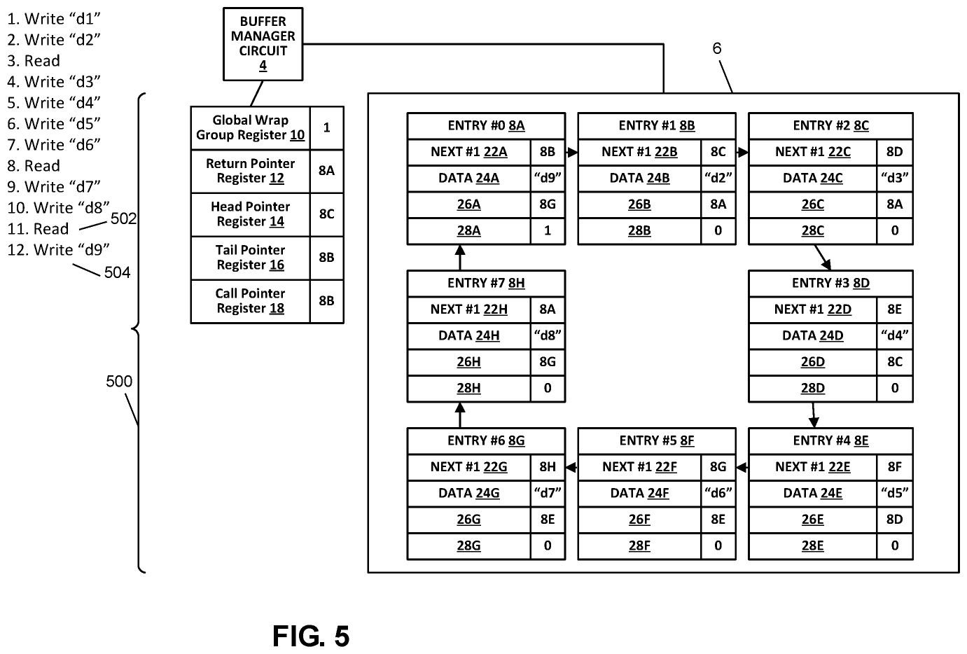

FIG. 5 is a block diagram of the state 500 of LIFO system of FIG. 4 after the first entry in the circular buffer has been overwritten. Since the state of the LIFO system 2 is illustrated in FIG. 4, FIG. 5 shows the state after a read request 502 and a write request 504 has been processed by the buffer manager circuit 4. Similar to the discussion of FIG. 3, in response to read request 502, the buffer manager circuit 4 read entry 8H and assigned return pointer register 12 to entry 8G (not shown in FIG. 5). In response to the write request 504, the buffer manager circuit updated entry 8A and assigned data field 24A to “d9” and copied the local wrap group field 28A from the global wrap group register 10. The buffer manager circuit 4 also copied the backward link field 26A from the return pointer register 12 which was entry 8G (prior to processing write request 504) so that the backward path of entries would exclude entry 8H which was read from previous read request 502. The buffer manager circuit 4 advanced both the read and call pointer registers one entry to point to entries 8A and 8B, respectively. When writing this overwritten entry, the global wrap count register is not incremented because the local wrap group field of the newly assigned tail pointer register, entry 8B, is not equal to the global wrap group register.

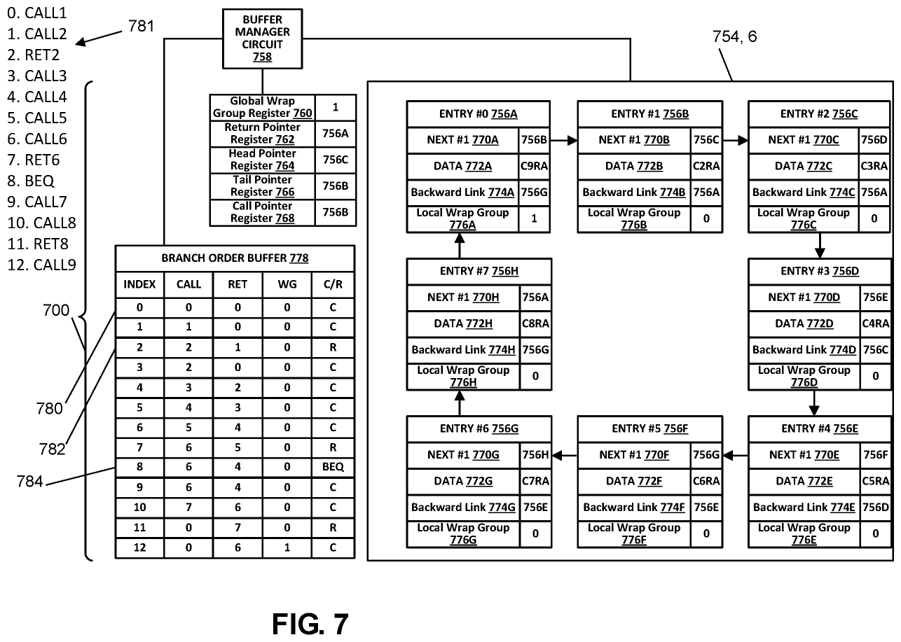

FIG. 6 is a block diagram of an exemplary processor-based system that includes an instruction processing system 600 of a central processing unit (CPU) system 602 and a RAS system 604. As described in more detail below, the RAS system 604 is configured to employ wrap tracking for addressing data overflow and mispredicting of instructions. For example, the RAS system 604 can at least employ a LIFO system including a fixed number of entries 605(1) . . . 605(n) similar to the LIFO system 2 in FIGS. 1-5. FIGS. 7-10 describe an exemplary operation of the LIFO system used as a RAS system 604 in the processor-based system in FIG. 6. Before describing the RAS system 604 in FIG. 6, other elements of the CPU system 602 in FIG. 6 are first described below.

The CPU system 602 may be provided in a system-on-a-chip (SoC) 606 as an example. In this regard, instructions 608 are fetched by an instruction fetch circuit 610 provided in a front end instruction stage 614F of the instruction processing system 600 from an instruction memory 616. The instruction memory 616 may be provided in or as part of a system memory in the CPU system 602 as an example. An instruction cache 618 may also be provided in the CPU system 602 to cache the instructions 608 from the instruction memory 616 to reduce latency in the instruction fetch circuit 610 fetching the instructions 608. The instruction fetch circuit 610 is configured to provide the instructions 608 as fetched instructions 608F into one or more instruction pipelines I₀-I_{N} in the instruction processing system 600 to be pre-processed, before the fetched instructions 608F reach an execution circuit 620 in a back end instruction stage 614B in the instruction processing system 600 to be executed. The instruction pipelines I₀-I_{N} are provided across different processing circuits or stages of the instruction processing system 600 to pre-process and process the fetched instructions 608F in a series of steps that are performed concurrently to increase throughput prior to execution of the fetched instructions 608F in the execution circuit 620.

With continuing reference to FIG. 6, a prediction circuit 622 (e.g., a branch prediction circuit) is also provided in the front end instruction stage 614F to speculate or predict a target address for a control flow fetched instruction 608F, such as a conditional branch instruction. The prediction of the target address by the prediction circuit 622 is used by the instruction fetch circuit 610 to determine the next fetched instructions 608F to fetch based on the predicted target address. The front end instruction stage 614F of the instruction processing system 600 in this example also includes an instruction decode circuit 624. The instruction decode circuit 624 is configured to decode the fetched instructions 608F fetched by the instruction fetch circuit 610 into decoded instructions 608D to determine the type of instructions 608 and actions required, which in turn is used to determine in which instruction pipeline I₀-I_{N} the fetched instructions 608F should be placed. Additionally, the instruction decode circuit 624 signals the RAS system 604 on various types of instructions including call instructions, return instructions, and conditional branch instructions. The decode circuit 624 sends a write signal 625 to RAS system 604 on call instructions, a read signal 627 on return instructions, and a notification signal on conditional branch instructions. The operation of RAS system 604, in response to these signals, will be discussed further in connection with the description of FIGS. 7-9 including its operation in response to these signals from the instruction decode circuit 624.

With continuing reference to FIG. 6, in this example, the decoded instructions 608D are then placed in one or more of the instruction pipelines I₀-I_{N} and are next provided to a register access circuit 626 in the back end instruction stage 614B of the instruction processing system 600. The register access circuit 626 is configured to determine if any register names in the decoded instructions 608D need to be renamed to break any register dependencies that would prevent parallel or out-of-order processing of the instructions 608. The instruction processing system 600 in FIG. 1 is capable of processing the fetched instructions 608F out-of-order, if possible, to achieve greater throughput performance and parallelism. However, the number of logical (i.e., architectural) registers provided in the CPU system 602 may be limited.

In this regard, the register access circuit 626 is provided in the back end instruction stage 614B of the instruction processing system 600. The register access circuit 626 is configured to call upon a register map table (RMT) to rename a logical source register operand and/or write a destination register operand of an instruction 608 to available physical registers in a physical register file (PRF).

It may be desired to provide for the CPU system 602 in FIG. 6 to have visibility to a large number of future instructions 608 (i.e., an instruction window) in order to extract a larger number of instructions 608 that can be executed independently, out-of-order for increased performance.

In this regard, the instruction processing system 600 includes an allocate circuit 646. The allocate circuit 646 is provided in the back end instruction stage 614B in the instruction pipeline I₀-I_{N} prior to a dispatch circuit 648. The allocate circuit 646 is configured to provide the retrieved produced value from the executed instruction 608E as the source register operand of an instruction 608 to be executed. Also in the instruction processing system 600 in FIG. 6, the dispatch circuit 648 is provided in the instruction pipeline I₀-I_{N} after the allocate circuit 646 in the back end instruction stage 614B. The dispatch circuit 648 is configured to dispatch the decoded instruction 608D to the execution circuit 620 to be executed when all source register operands for the decoded instruction 608D are available. The execution circuit 620 and a writeback circuit 650 are provided in the back end instruction stage 614B. The execution circuit 620 signals the RAS system 604 when call instructions, return instructions, and conditional branch instructions are committed to memory. Additionally, execution circuit 620 will send a mispredict signal 652 to RAS system 604 when an instruction that has been predictively prefetched has resolved to be mispredicted. This situation will occur, for example, when prediction circuit 622 selects one of multiple paths of instructions from a conditional branch instruction prior to the resolution of the branch condition and that subsequent resolution of the branch condition resolves to an alternative path of instructions. RAS system 604 will be discussed further in connection with the description of FIGS. 7-9 including its operation in response to these signals from the execution circuit 620.

FIG. 7 is a block diagram of the state 700 of the RAS System 604 of FIG. 6 after the first entry in the RAS 754 has been overwritten. RAS 754 containing 8 entries 756A-756H. RAS System 604 also includes a buffer manager circuit 758. The buffer manager circuit 758 utilizes a global wrap group register 760 which stores a value representing the number of iterations entries 756A-756H of RAS 754 have been written. The buffer manager circuit 758 also utilizes a return pointer register 762 which stores the address of one of the entries 756A-756H to indicate the particular entry to return on a read request. A read request, in this embodiment, is a read signal 627 from instruction decode circuit 624 which resulted from decoding a return instruction. Please note that for exemplary purposes the size of the RAS 754 is fixed to eight (8) entries but the concepts described herein may easily be extended to various sizes. Please also note that registers and circuits are implemented in hardware but that they can be implemented in software logic and software variables.

The buffer manager circuit 758 may also utilize head pointer register 764 which stores the address of one of the entries 756A-756H to indicate the start of a list within RAS 754 and tail pointer register 766 which stores the address of one of the entries 756A-756H to indicate the end of a list within RAS 754. The buffer manager circuit 758 may also utilize a call pointer register 768 which stores the address of one of the entries 756A-756H to indicate the entry of RAS 754 to write in response to the next write request. A write request, in this embodiment, is a write signal 625 from the instruction decode circuit 624 which resulted from decoding a subroutine call instruction.

Entries 756A-756H include next fields 770A-770H, data fields 772A-772H, backward link fields 774A-774H, and local wrap group fields 776A-776H. Next field 770A-770H contains the address of the next forward entry in RAS 754 (shown as “NEXT #1” in FIG. 7). As illustrated in FIG. 7, entry 756A's next field 770A contains the address of entry 756B, entry 756B's next field 770B contains the address of entry 756C, and so on through to entry 756H linking the entries clockwise in a circular fashion. Thus, next fields 770A-770H statically link entries 756A-756H in a forward direction.

Data fields 772A-772H contain the return addresses to be returned when the respective entry is read. Backward link fields 774A-774H store the address of the next entry to return after the current entry is read. In response to a write request, the backward link field 774A-774H of the written entry will contain the address of the next entry to return after the written entry is returned. As will be described later, backward link fields 774A-774H will form a list of entries to be read on a series of read requests. Local wrap group fields 776A-776H contain the value of the global wrap group register 760 when the respective entry 756A-756H was written, reflecting the number of iterations the RAS 754 have been written.

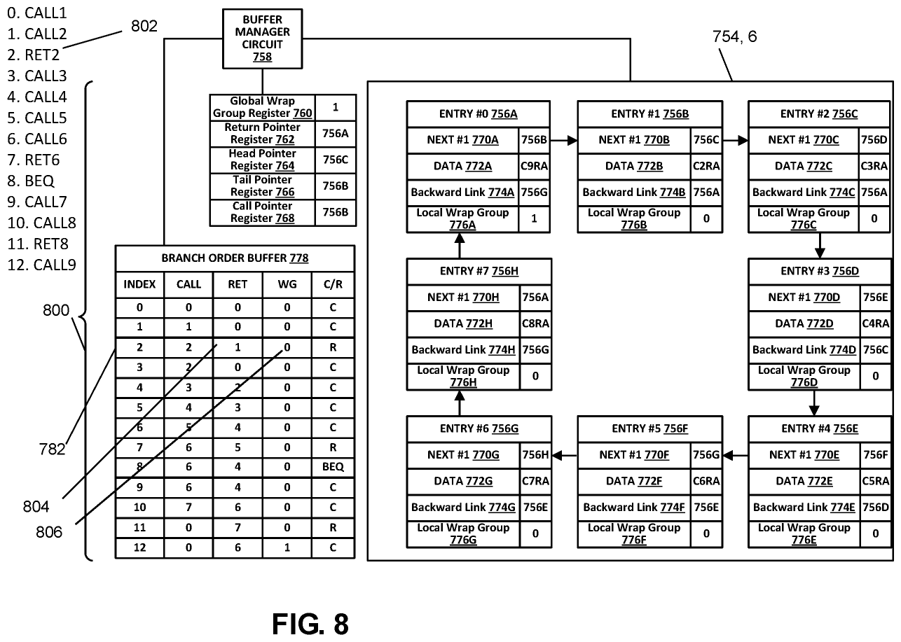

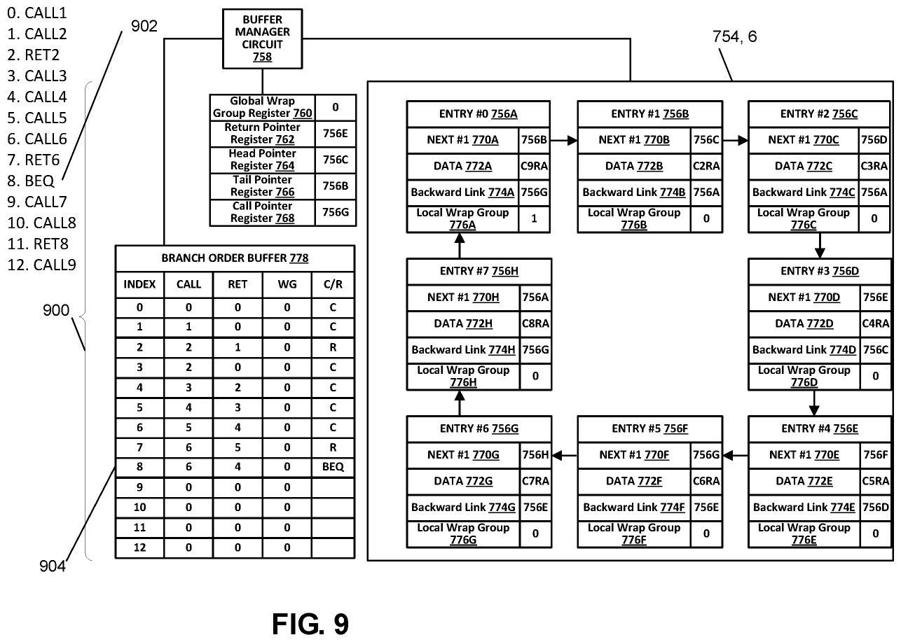

The buffer manager circuit 758 also utilizes the branch order buffer 778. The branch order buffer 778 maintains a snapshot of the state of the RAS System 604 in response to processing a read, write, or notification signal from the instruction decode circuit 624. As will be described further in connection with the disclosure of FIGS. 8-9, the buffer manager circuit 758 will utilize the information stored in the branch order buffer 778 to advantageously manage the RAS System 604 when receiving commit signals, also known as retire signals, from execution circuit 620 to advantageously restore the state of RAS System 604 in response to a mispredict signal 652. In particular, the buffer manager circuit 758 writes a new row to the branch order buffer on each of those signals. The buffer manager circuit 758 writes the state of the call pointer register 768, the return pointer register 762, and the global wrap group register 760 just prior to processing a particular signal. The buffer manager circuit 758 also writes whether the signal received mapped to a call, return, or conditional branch instruction. For example, buffer manager circuit 758 wrote the data in row 780 in response to receiving a write signal 625 from instruction decode circuit 624 after decoding instruction CALL1. Additionally, buffer manager circuit 758 wrote the data in row 782 in response to receiving a read signal 627 from instruction decode circuit 624 after decoding instruction RET2. Moreover, buffer manager circuit 758 wrote the data in row 784 in response to receiving a notification signal that a conditional branch instruction (e.g., BEQ—branch on equality of two registers).

The state 700 of RAS System 604 is the result of the buffer manager circuit 758 processing the signals resulting from sequence of instructions 781. Sequence of instructions 781 are analogous to the list of write and read requests 402 in FIG. 5. As a result, the states of entries 756A-756H are similar to the states of entries 8A-8H except for the data fields. As mentioned above, data fields 772A-772H include the return addresses for an associated call subroutine. Also, the states of the global wrap group register, return pointer register, call pointer register, head pointer register, and tail pointer register are the same between FIGS. 5 and 7 since both the sequence of instructions 781 and list of read and write requests 402 overwrote the first entry of RAS 754 and circular buffer 6 respectively.

Please note row 780. Row 780 was written when a write request was received for CALL1. The data for that write request was written to entry 756A (the data shown in FIG. 7 for entry 756A is the data after processing the write signal 625 associated with CALL9). When the read signal 627 for RET2 was received, buffer manager circuit 758 returned the address stored in data field 772B. However, when the write signal 625 for CALL9 was received, buffer manager circuit 758 overwrote entry 756A including data field 772A with the return address for CALL9 (“C9RA”), backward link field 774A to point to entry 756G and local wrap group field 776A to the value of global wrap group register 760.

FIG. 8 is a block diagram of state 800 of the RAS system 604 of FIG. 6 when a commit signal for return instruction 802 has been processed by buffer manager circuit 758. As will be described next, the state 700 prior to receiving a commit signal for RET2 is equal to the state 800 after the buffer manager circuit 758 processes the commit signal. In other words, updates to registers 760, 762, or 768 are avoided on a commit signal.

Execution circuit 620 sends commit signals to RAS system 604 when an instruction has completed processing in the instruction processing system 600. Commit signals for instructions are received in the same order as the instruction sequence. The buffer manager circuit 758 may maintain a register whose value enables the buffer manager circuit 758 to index into a row of branch order buffer 778. As such, the buffer manager circuit 758 directly accesses the row of branch order buffer 778 that is associated with the instruction for which the commit signal was received. In FIG. 8, buffer manager circuit 758 directly indexes row 782 that was written when RET2 was received. Buffer manager circuit 758 utilizes value 804 as an index into RAS 754 to locate entry 756B. By comparing wrap group field 806 in branch order buffer 778 with local wrap group field 776B, the buffer manager circuit 758 determines that entry 756B has not been overwritten because they are equal and, thus, entry 756B is eligible to be retired. If local wrap group field 776B didn't equal wrap group field 806, the buffer manager circuit 758 would have determined that the entry was overwritten and not eligible to be retired. In either case, since RAS system 604 allows overwrites, RAS system 604 advantageously need not perform any resetting of fields in an entry on a commit signal, nor does it need to change the state of the registers (762, 764, 766, and 768), unlike conventional approaches to RAS systems.

FIG. 9 is a block diagram illustrating of the state 900 of the RAS System when a conditional branch instruction BEQ 902 has been determined to be mispredicted. Since instruction processing system 600 is a predictive fetch system, the read and write signals, 627 and 625 respectively, sent to RAS system 604 are done prior to the determination of whether the associated instruction has been properly predicted. Resolution of whether an instruction is properly predicted is done in execution circuit 620. If the execution circuit 620 determines whether an instruction was mispredicted, it has to flush the back end instruction stage 614B of all the instructions resulting from the mispredicted instruction and send a mispredict signal to the RAS system 604 so RAS system 604 can reset itself. Referring to FIG. 9, in response to a mispredict signal 652, buffer manager circuit 758 directly accesses row 904 in the branch order buffer 778, resets the call pointer register 768 to entry 756G which is referenced in the CALL field of row 904, and resets the return pointer register 762 to entry 756E which is referenced in the RET field of row 904. The buffer manager circuit 758 may reset the subsequent rows of the branch order buffer 778 or simply reset its register whose value enables the buffer manager circuit 758 to index into the next available row of branch order buffer 778. This advantageous approach to managing RAS system 604 saves energy.

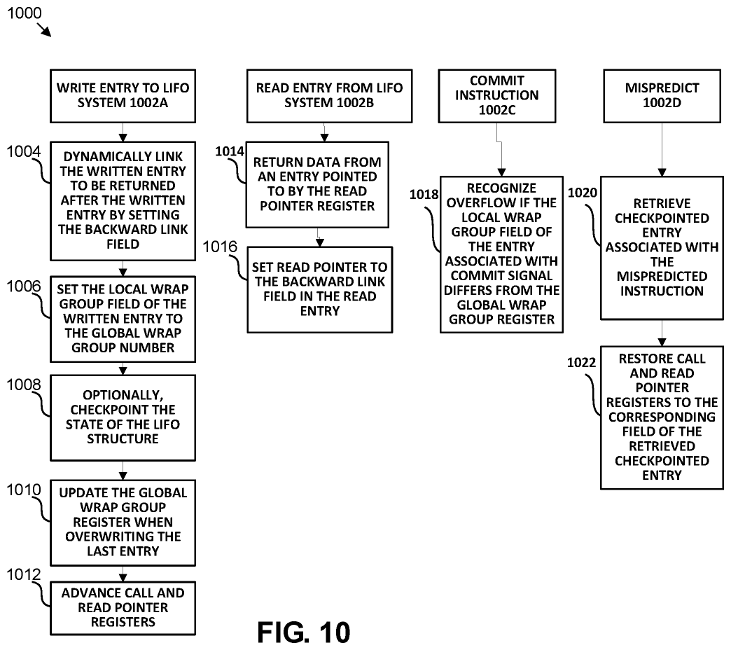

FIG. 10 is a flow chart 1000 for the operations 1002A-D of a buffer manager circuits (4 and 758) which utilize wrap tracking to allow data overwrite and maintain the order of the most recent entries in accordance with the present disclosure. As discussed above in connection with FIGS. 1-5, buffer manager circuit 4 manages the state of the LIFO system to allow entries to be overwritten while also maintaining the most recent entries in order. As discussed above in connection with FIGS. 6-9, buffer manager circuit 758, while including all the functionality of buffer manager circuit 4, also includes functionality to manage the state of a LIFO system used as a RAS system with a predictive instruction fetch processing system. As such, operations 1002A-B are performed by both buffer manager circuits 4 and 758. Operations 1002C-D are only performed by buffer manager circuit 758.

Writing an entry to a LIFO system, for example circular buffer 6 or 754, starts at block 1004. At block 1004, the method dynamically links the written entry of the LIFO system to previous valid entry to be returned after the written entry by setting the backward link entry field in the written entry. At block 1006, the writing operation sets the local wrap group field of the written entry to the global wrap group number. At optional block 1008, the writing operation checkpoints the state of the LIFO system in case the LIFO system is deployed in a RAS system. In doing, checkpoint information would include the cause of the write, the entry pointed to by a call pointer register, and the entry pointed to by a read pointer register. Optional block 1008 is performed by buffer manager circuit 758 since the LIFO system is deployed in RAS system 604. At block 1010, the writing operation determines whether to update the global wrap group if the next entry to be written starts a new iteration of writing entries in the LIFO system. At block 1012, the writing operation increments the call and read pointer registers of the LIFO system.

Reading an entry from a LIFO system, for example circular buffer 6 or 754, starts at block 1014. At block 1014, the reading operation returns data from an entry in the LIFO system which was pointed to by the read pointer. At block 1016, the reading operation sets the return pointer to the previous backward link entry field of the read entry.

Committing an instruction in a predictive instruction processing system starts at block 1018. At block 1018, the committing operation recognizes overflow if the entry associated with the commit signal contains a local wrap group number that differs from the global wrap group.

Mis-predicting an instruction in a predictive instruction processing system starts at block 1020. The mis-predicting operation retrieves the checkpointed entry associated with the mis-predicted instruction. At block 1022, the mis-predicting operation restores the call and read pointer registers to the retrieved checkpointed entry.

The circular buffer employing wrap tracking for addressing data overflow according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

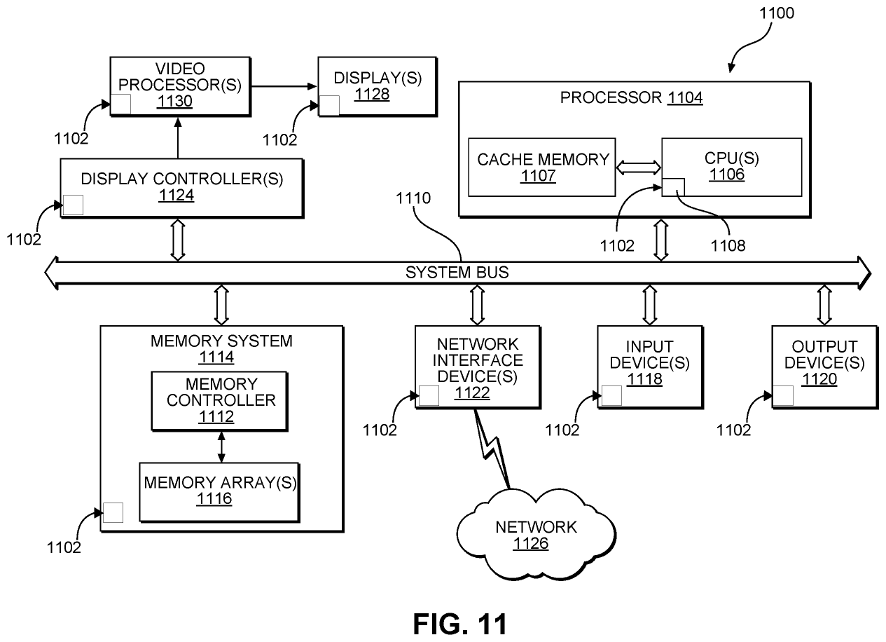

In this regard, FIG. 11 is an example of a processor-based system 1100 that can include a LIFO system 1102, such as the LIFO systems shown in FIGS. 1 and 6, wherein the LIFO system 1102 includes a buffer manager circuit 1108 configured to at least utilize wrap tracking for addressing data overflow while maintaining the most recently written entries according to aspects disclosed herein. For example, the LIFO system 1102 may include the buffer manager circuits 4, 758 in FIGS. 1 and 7 previously described. In this example, the processor-based system 1100 includes a processor 1104 that includes one or more CPUs 1106 and cache memory 1107. Each CPU 1106 includes a LIFO system 1102, which for example, could be the RAS system 604 in FIGS. 6 and 7. The RAS system 604 includes buffer manager circuit 758 and branch order buffer 778 to address resetting the state of RAS system 604 on a mispredict signal 652 according to aspects disclosed herein.

With continuing reference to FIG. 11, the CPUs 1106 can issue memory access requests over a system bus 1110. Memory access requests issued by the CPUs 1106 over the system bus 1110 can be routed to a memory controller 1112 in a memory system 1114 that includes one or more memory arrays 1116. Although not illustrated in FIG. 11, multiple system buses 1110 could be provided, wherein each system bus 1110 constitutes a different fabric. For example, the CPUs 1106 can communicate bus transaction requests to the memory system 1114 as an example of a slave device.

Other master and slave devices can be connected to the system bus 1110. As illustrated in FIG. 11, these devices can include the memory system 1114, one or more input devices 1118, one or more output devices 1120, one or more network interface devices 1122, and one or more display controllers 1124. The input device(s) 1118 can include any type of input device, including but not limited to input keys, switches, voice processors, etc. The output device(s) 1120 can include any type of output device, including but not limited to audio, video, other visual indicators, etc. The network interface device(s) 1122 can be any devices, including a modem, configured to allow exchange of data to and from a network 1126. The network 1126 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1122 can be configured to support any type of communications protocol desired.

The CPUs 1106 can also be configured to access the display controller(s) 1124 over the system bus 1110 to control information sent to one or more displays 1128. The display controller(s) 1124 sends information to the display(s) 1128 to be displayed via one or more video processors 1130, which process the information to be displayed into a format suitable for the display(s) 1128. The display(s) 1128 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium wherein any such instructions are executed by a processor or other processing device, or combinations of both. The CPUs 602 described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered aspects/clauses:
1. An apparatus, comprising:
   a circular buffer, comprising:
      a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer, wherein one of the fixed number of entries is a first entry and one of the fixed number of entries is a most recently added entry;
   a return pointer register configured to track the most recently added entry in the fixed number of entries;
   a global wrap group register configured to store a value representing a number of iterations the circular buffer has been written; and
   a buffer manager circuit, in response to a write request, configured to:
      determine a next available entry of the fixed number of entries;
      update the local wrap group field of the next available entry to the value of the global wrap group register; and
      update the second field of the next available entry to the return pointer register.
2. The apparatus of clause 1, wherein the buffer manager circuit, in response to the read request, is further configured to update the return pointer register to the value of the second field of the entry.
3. The apparatus of clause 1, wherein the buffer manager circuit is further configured to increment the global wrap group register in response to over writing the first entry.
4. The apparatus of clause 2 or 3, further comprising a branch order buffer, wherein the buffer manager circuit is further configured to store a state of the return pointer register and the global wrap group register in the branch order buffer in response to a read or write request.
5. The apparatus of clause 4, wherein the buffer manager circuit is further configured to restore the return pointer register and the global wrap group register from the branch order buffer in response to a mispredict signal.
6. The apparatus of clause 4 or 5, wherein the buffer manager circuit, in response to a commit signal associated with an entry, is further configured to recognize whether the entry has been previously overwritten by being configured to compare the local wrap group field of the entry with the global wrap group register.
7. A method, comprising:
   establishing a circular buffer, comprising:
      a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer, wherein one of the fixed number of entries is a first entry and one of the fixed number of entries is a most recently added entry;
   establishing a return pointer register configured to track the most recently added entry in the fixed number of entries; and
   establishing a global wrap group register configured to store a value representing a number of iterations the circular buffer has been written; and
   in response to a write request,
      determining a next available entry of the fixed number of entries;
      updating the local wrap group field of the next available entry to the value of the global wrap group register; and
      updating the second field of the next available entry to the return pointer register.
8. The method of clause 7, further comprising:
   updating the return pointer register to the value of the second field of the entry in response to the read request.
9. The method of clause 7 or 8, further comprising:
   incrementing the global wrap group register in response to over writing the first entry.
10. The method of clause 9, further comprising:
   storing a state of the return pointer register and the global wrap group register in response to a read or write request.
11. The method of clause 10, further comprising:
   restoring the return pointer register and the global wrap group register in response to a mispredict signal.
12. The method of clause 10, further comprising:
   recognizing whether the entry has been previously overwritten by comparing the local wrap group field of the entry with the global wrap group register in response to a commit signal associated with the entry.
13. A non-transitory computer-readable medium having stored thereon computer executable instructions which, when executed by a processor, cause the processor to:
   establish a circular buffer, comprising:
      a fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return on a read request after the entry is read from the circular buffer, wherein one of the fixed number of entries is a first entry and one of the fixed number of entries is a most recently added entry;
   establish a return pointer register configured to track the most recently added entry in the fixed number of entries; and
   establish a global wrap group register configured to store a value representing a number of iterations the circular buffer has been written; and
   in response to a write request:
      determine a next available entry of the fixed number of entries;
      update the local wrap group field of the next available entry to the value of the global wrap group register; and
      update the second field of the next available entry to the return pointer register.
14. The non-transitory computer-readable medium of clause 13, wherein the computer executable instructions which, when executed by the processor, further cause the processor to update the return pointer register to the value of the second field of the entry in response to the read request.
15. The non-transitory computer-readable medium of clause 13 or 14, wherein the computer executable instructions which, when executed by the processor, further cause the processor to increment the global wrap group register in response to over writing the first entry.
16. The non-transitory computer-readable medium of clauses 13-15, wherein the computer executable instructions which, when executed by the processor, further cause the processor to store a state of the return pointer register and the global wrap group register in response to a read or write request.
17. The non-transitory computer-readable medium of clause 16, wherein the computer executable instructions which, when executed by the processor, further cause the processor to restore the return pointer register and the global wrap group register in response to a mispredict signal.
18. The non-transitory computer-readable medium of clause 16 or 17, wherein the computer executable instructions which, when executed by the processor, further cause the processor to recognize whether the entry has been previously overwritten by comparing the local wrap group field of the entry with the global wrap group register in response to a commit signal associated with the entry.

1. An apparatus for performing wrap tracking to address data overflow in a circular buffer, the circular buffer comprising a fixed number of entries, the fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return after the entry is read from the circular buffer, wherein one of the fixed number of entries is a first entry and one of the fixed number of entries is a most recently added entry, the apparatus comprising:
a return pointer register configured to store an address of one of the fixed number of entries;
a global wrap group register configured to store an iteration value representing a number of iterations the circular buffer has been written;
a hardware buffer manager circuit configured to receive a write request;
in response to the write request, the hardware buffer manager circuit configured to:
determine a next available entry of the fixed number of entries in the circular buffer;
update a local wrap group field of the next available entry to the iteration value of the global wrap group register; and
update a second field of the next available entry to the address.

2. The apparatus of claim 1, wherein the hardware buffer manager circuit, in response to a read request, is further configured to:
update the return pointer register to a value of the second field of the entry.

3. The apparatus of claim 1, wherein the hardware buffer manager circuit is further configured to increment the global wrap group register in response to overwriting the first entry.

4. The apparatus of claim 3, wherein the hardware buffer manager circuit is further configured to store a state of the return pointer register and the global wrap group register in a branch order buffer in response to a read or write request.

5. The apparatus of claim 4, wherein the hardware buffer manager circuit is further configured to restore the return pointer register and the global wrap group register from the branch order buffer in response to a mispredict signal.

6. The apparatus of claim 4, wherein the hardware buffer manager circuit, in response to a commit signal associated with a second entry, is further configured to recognize whether the second entry has been previously overwritten by being configured to compare the local wrap group field of the second entry with the global wrap group register.

7. A method of performing wrap tracking to address data overflow in a circular buffer, the circular buffer comprising a fixed number of entries, the fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return after the entry is read from the circular buffer, wherein one of the fixed number of entries is a first entry and one of the fixed number of entries is a most recently added entry, the method comprising:
receiving a write request; and
in response to the write request:
determining a next available entry of the fixed number of entries in the circular buffer;
updating a local wrap group field of the next available entry to an iteration value of a global wrap group register, the local wrap group field configured to identify which iteration of writing the circular buffer the next available entry was last written; the global wrap group register configured to store the iteration value representing a number of iterations the circular buffer has been written; and
updating a second field of the next available entry to an address stored in a return pointer register, the return pointer register configured to track the most recently added entry in the fixed number of entries.

8. The method of claim 7, further comprising:
updating the return pointer register to a value of the second field of the entry in response to a read request.

9. The method of claim 7, further comprising:
incrementing the global wrap group register in response to overwriting the first entry.

10. The method of claim 9, further comprising:
storing a state of the return pointer register and the global wrap group register in response to a read or write request.

11. The method of claim 10, further comprising:
restoring the return pointer register and the global wrap group register in response to a mispredict signal.

12. The method of claim 10, further comprising:
recognizing whether the entry has been previously overwritten by comparing the local wrap group field of the entry with the global wrap group register in response to a commit signal associated with the entry.

13. A non-transitory computer-readable medium for performing wrap tracking to address data overflow in a circular buffer, the circular buffer comprising a fixed number of entries, the fixed number of entries statically linked in a first direction in which data is written to the circular buffer, an entry of the fixed number of entries comprising a local wrap group field configured to identify which iteration of writing the circular buffer the entry was last written, and a second field configured to store a link to a next entry to return after the entry is read from the circular buffer, wherein one of the fixed number of entries is a first entry and one of the fixed number of entries is a most recently added entry, the non-transitory computer-readable medium having stored thereon first computer executable instructions which, when executed by a processor, cause the processor to:
receive a write request; and
in response to the write request:
determine a next available entry of the fixed number of entries in the circular buffer;
update a local wrap group field of the next available entry to an iteration value of a global wrap group register, the local wrap group field configured to identify which iteration of writing the circular buffer the next available entry was last written, the global wrap group register configured to store the iteration value representing a number of iterations the circular buffer has been written; and
update a second field of the next available entry to an address stored in a return pointer register, the return pointer register configured to track the most recently added entry in the fixed number of entries.

14. The non-transitory computer-readable medium of claim 13 having stored thereon second computer executable instructions which, when executed by the processor, cause the processor to update the return pointer register to a value of the second field of the entry in response to a read request.

15. The non-transitory computer-readable medium of claim 13 having stored thereon third computer executable instructions which, when executed by the processor, cause the processor to increment the global wrap group register in response to overwriting the first entry.

16. The non-transitory computer-readable medium of claim 15 having stored thereon fourth computer executable instructions which, when executed by the processor, further cause the processor to store a state of the return pointer register and the global wrap group register in response to a read or write request.

17. The non-transitory computer-readable medium of claim 16 having stored thereon fifth computer executable instructions which, when executed by the processor, cause the processor to restore the return pointer register and the global wrap group register in response to a mispredict signal.

18. The non-transitory computer-readable medium of claim 16 having stored thereon sixth computer executable instructions which, when executed by the processor, cause the processor to recognize whether the entry has been previously overwritten by comparing the local wrap group field of the entry with the global wrap group register in response to a commit signal associated with the entry.

19. A method for updating a Last-In, First-Out (LIFO) system, comprising:
writing an entry into the LIFO system;
dynamically linking the entry of the LIFO system to a previous valid entry to be returned after the entry by setting a backward link entry field in the entry;
setting a local wrap group field of the entry to a global wrap group number; and
updating a global wrap group register if a next entry to be written would start a new iteration of writing entries in the LIFO system.

20. The method of claim 19, further comprising:
checkpointing a state of the LIFO system into a branch order buffer including entries pointed to by a call pointer register and a read pointer register.

21. The method of claim 19, further comprising:
in response to reading an entry from the LIFO system:
returning data from an entry pointed to by a read pointer register; and
setting the read pointer register to a backward link field in the entry.

22. The method of claim 21, further comprising:
in response to receiving a commit signal associated with a second entry in the LIFO system:
recognizing overflow if a value of the local wrap group field of the second entry differs from a value of the global wrap group register.

23. The method of claim 20, further comprising:
in response to receiving a mispredict signal:
retrieving a checkpointed entry in the branch order buffer associated with a mispredicted instruction; and
restoring the call pointer register with a call pointer stored in the checkpointed entry; and
restoring the read pointer register with a read pointer stored in the checkpointed entry.
